(19) United States
(12) Patent Application Publication
(10) Pub. No.: US 2026/0160586 A1
(43) Pub. Date: Jun. 11, 2026

(54) Portable Ullage Measurement Gauge

(71) Applicant: Firstex Industries, Inc., Grand Prairie, TX (US)

(72) Inventor: Morgan Lee, Grand Prairie, TX (US)

(21) Appl. No.: 18/973,715

(22) Filed: Dec. 9, 2024

(51) Int. Cl. G01F 23/00; G01B 3/1005

(52) U.S. Cl. CPC G01F 23/0023; G01B 3/1005; G01B 2003/1023

(57) ABSTRACT

A portable ullage gauge includes a frame, a measurement tape assembly and a wiper assembly. The measurement tape assembly includes a reel rotatably connected to the frame and a measurement tape wound around the reel. The wiper assembly is connected to the frame and includes a first wiper element and a second wiper element that are spaced apart such that the measurement tape passes between the first and second wiper elements, wherein the second wiper element is stationary and the first wiper element is rotatable towards the second wiper element to adjustably contact both sides of the measurement tape. In some embodiments, the frame includes a notch that is alignable with an opening in the reel such that the measurement tape is removeable, a wiper ring is connected to a front end of the frame, and/or a plumb bob holder is connected to the wiper assembly or the frame.

### CROSS-REFERENCE TO RELATED APPLICATIONS

Not applicable.

### TECHNICAL FIELD OF THE INVENTION

The present invention relates in general to the field of measurement gauges, and more particularly to a measurement gauge for measuring the ullage associated with a material level within a tank.

### STATEMENT OF FEDERALLY FUNDED RESEARCH

Not applicable.

### BACKGROUND OF THE INVENTION

Without limiting the scope of the invention, its background is described in connection with chains and chain links for heavy equipment.

While loading liquid cargo into large tanks used to transport the cargo, the volume of liquid in the tank is typically determined by measuring the “ullage” of the tank after being loaded. Ullage is generally defined as the amount by which a tank falls short of being full and is directly related to the distance between the top of the cargo and the underside of the top of the tank. In many commercial tanker cars or the like, the ullage measurement is made from a special hatch, i.e., ullage hatch, which sets atop the main hatch into the cargo tank and which is opened to measure the liquid level with a hand-held portable ullage gauge. Once the ullage measurement is made, a standard set of ullage tables for that particular tank is consulted to establish the actual volume of cargo present in the tank. Tanks carrying crude oil or liquid petroleum products in bulk are commonly calibrated in cubic feet, cubic meters, or barrels.

When portable ullage gauges are used, which typically includes a windable tape measure connected to a plumb bob, oil can easily adhere to the measurement surfaces as the tape is wound up after a measurement. Although prior art devices for wiping the oil from the tape measure during rewinding are adequate for their intended purpose, there remains a need for greater control over the amount of pressure applied to the wipe elements, especially when the same ullage gauge is used for measuring oils of different viscosities. Such prior art devices, however, fail to provide an integral wiper for the plumb bob, which comes in direct contact with the oil during measurement. Moreover, the prior art does not provide means for storing the plumb bob in a secure position when not in use, which makes the portable ullage gauge harder to carry and store.

Accordingly, there is a need for an improved portable ullage measurement gauge.

### SUMMARY OF THE INVENTION

In one embodiment of the present disclosure, a portable ullage gauge includes a frame, a measurement tape assembly and a wiper assembly. The measurement tape assembly includes a reel rotatably connected to the frame and a measurement tape wound around the reel, wherein the reel includes an opening configured to secure a fixed end of the measurement tape. The wiper assembly is connected to the frame and includes a first wiper element and a second wiper element that are spaced apart such that the measurement tape passes between the first wiper element and the second wiper element. The second wiper element is stationary and the first wiper element is rotatable towards the second wiper element to adjustably contact both sides of the measurement tape. The frame includes a notch that is alignable with the opening in the reel such that the measurement tape is removeable.

In one aspect, the notch is located on an upper or lower portion of the frame member. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, the reel is rotatably connected between the first circular or semi-circular central portion of the first plate member and the second circular or semi-circular central portion of the second plate member, and the notch is on the first circular or semi-circular central portion, the second circular or semi-circular central portion, or both. In another aspect, the wiper assembly further includes an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a wiper ring is connected to a front end of the frame. In another aspect, a slot is formed in the wiper ring. In another aspect, a plumb bob holder is connected to the wiper assembly or the frame. In another aspect, the plumb bob holder includes one or more clips, semi-circular rings, hook and loop fasteners, or magnets.

In another embodiment of the present disclosure, a portable ullage gauge includes a frame, a measurement tape assembly, a wiper assembly connected to the frame, and a wiper ring connected to a front end of the frame. The measurement tape assembly includes a reel rotatably connected to the frame and a measurement tape wound around the reel. The wiper assembly includes a first wiper element and a second wiper element that are spaced apart such that the measurement tape passes between the first wiper element and the second wiper element. The second wiper element is stationary and the first wiper element is rotatable towards the second wiper element to adjustably contact both sides of the measurement tape.

In one aspect, a slot is formed in the wiper ring. In another aspect, an opening in the reel is configured to secure a fixed end of the measurement tape, and a notch in the frame that is alignable with the opening in the reel such that the measurement tape is removeable. In another aspect, the notch is located on an upper or lower portion of the frame. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, and the reel is rotatably connected between the first circular or semi-circular central portion of the first plate member and the second circular or semi-circular central portion of the second plate member. In another aspect, the notch is on the first circular or semi-circular central portion, the second circular or semi-circular central portion, or both. In another aspect, the wiper assembly further comprises an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a plumb bob holder is connected to the wiper assembly or the frame. In another aspect, the plumb bob holder includes one or more clips, semi-circular rings, hook and loop fasteners, or magnets.

In another embodiment of the present disclosure, a portable ullage gauge includes a frame, a measurement tape assembly, a wiper assembly connected to the frame, and a plumb bob holder connected to the wiper assembly or the frame. The measurement tape assembly includes a reel rotatably connected to the frame and a measurement tape wound around the reel. The wiper assembly includes a first wiper element and a second wiper element that are spaced apart such that the measurement tape passes between the first wiper element and the second wiper element. The second wiper element is stationary and the first wiper element is rotatable towards the second wiper element to adjustably contact both sides of the measurement tape.

In oner aspect, the plumb bob holder includes one or more clips, semi-circular rings, hook and loop fasteners, or magnets. In another aspect, an opening in the reel is configured to secure a fixed end of the measurement tape, and a notch in the frame is alignable with the opening in the reel such that the measurement tape is removeable. In another aspect, the notch is located on an upper or lower portion of the frame member. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, and the reel is rotatably connected between the first circular or semi-circular central portion of the first plate member and the second circular or semi-circular central portion of the second plate member. In another aspect, the notch is on the first circular or semi-circular central portion, the second circular or semi-circular central portion, or both. In another aspect, the wiper assembly includes an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a wiper ring is connected to a front end of the frame. In another aspect, a slot is formed in the wiper ring.

In another embodiment of the present disclosure, a method of using a portable ullage gauge includes providing a portable ullage gauge as described in any of the foregoing embodiments and measuring an ullage of a filled or partially filled container, such as a tank.

In one aspect, the method includes removing or replacing the measurement tape by aligning the notch in the frame with the opening in the reel. In another aspect, the method includes wiping a liquid or material off the measurement tape using the first and second wiper elements. In another aspect, the method includes wiping a liquid or material off the plumb bob using the wiper ring. In another aspect, the method includes storing the plumb bob using the plumb bob holder. In another aspect, an opening in the reel is configured to secure a fixed end of the measurement tape, and a notch in the frame is alignable with the opening in the reel such that the measurement tape is removeable. In another aspect, the notch is located on an upper or lower portion of the frame member. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, the reel is rotatably connected between the first circular or semi-circular central portion of the first plate member and the second circular or semi-circular central portion of the second plate member, and the notch is on the first circular or semi-circular central portion, the second circular or semi-circular central portion, or both. In another aspect, the wiper assembly further includes an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a wiper ring is connected to a front end of the frame. In another aspect, a slot is formed in the wiper ring. In another aspect, a plumb bob holder is connected to the wiper assembly or the frame. In another aspect, the plumb bob holder includes one or more clips, semi-circular rings, hook and loop fasteners, or magnets.

Note that the invention is not limited to the embodiments described herein, instead it has the applicability beyond the embodiments described herein. The brief and detailed descriptions of this disclosure are given in the following.

### BRIEF DESCRIPTION OF THE DRAWINGS

For a more complete understanding of the features and advantages of the present invention, reference is now made to the detailed description of the invention along with the accompanying figures and in which:

FIG. 1 is a forward isometric view of a portable ullage measurement gauge in a measurement position in accordance with one embodiment of the present disclosure;

FIG. 2 is a top view of the ullage measurement gauge in accordance with one embodiment of the present disclosure;

FIG. 3 is a side view of the ullage measurement gauge in accordance with one embodiment of the present disclosure;

FIGS. 4A-4B are a side and top views of the frame in FIGS. 1-3 in accordance with one embodiment of the present disclosure;

FIG. 5 is a close-up view of the attachment of the measurement tape to the reel in FIGS. 1-3 in accordance with one embodiment of the present disclosure;

FIG. 6 is a forward isometric view of the ullage measurement gauge with the plumb bob in a stored position in accordance with one embodiment of the present disclosure;

FIG. 7 is a rear isometric view of the ullage measurement gauge with the plumb bob in a stored position in accordance with another embodiment of the present disclosure;

FIG. 8 is a forward isometric exploded view of the ullage measurement gauge in accordance with one embodiment of the present disclosure; and

FIG. 9 is a flow chart of a method of using the ullage measurement gauge in accordance with one embodiment of the present disclosure.

It is noted that the drawings are intended to depict only various embodiments of the present disclosure and therefore should not be considered as limiting the scope thereof. It is further noted that the drawings are not necessarily to scale, and therefore relative dimensions or sizes of the illustrated elements can greatly vary.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various elements and components are described below to provide an example of each claimed embodiment. They do not limit any claimed embodiment. Any claimed embodiment may cover gauges or methods that are different from those described above and below. The drawings and descriptions are for illustrative, rather than restrictive, purposes.

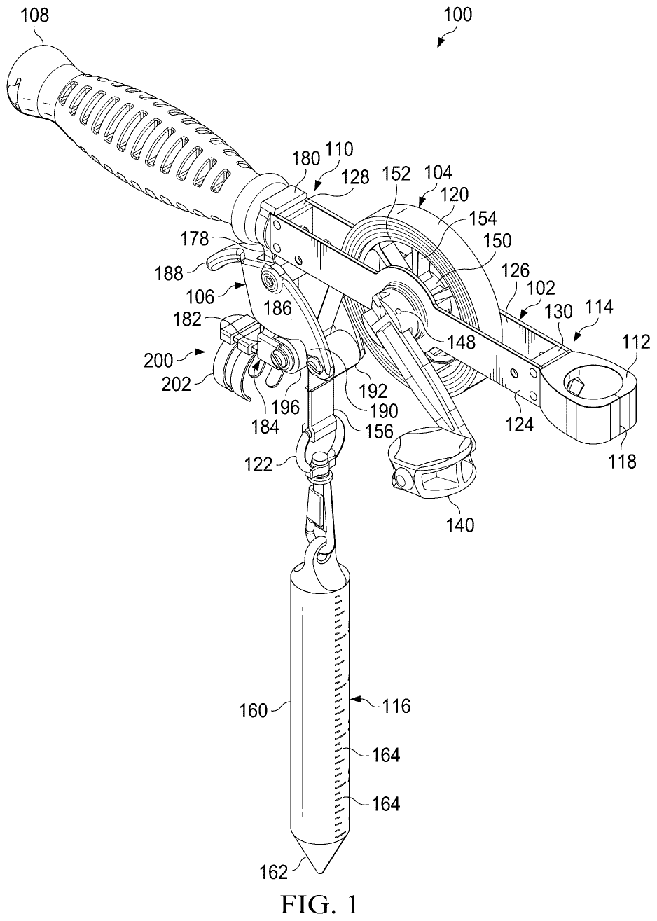

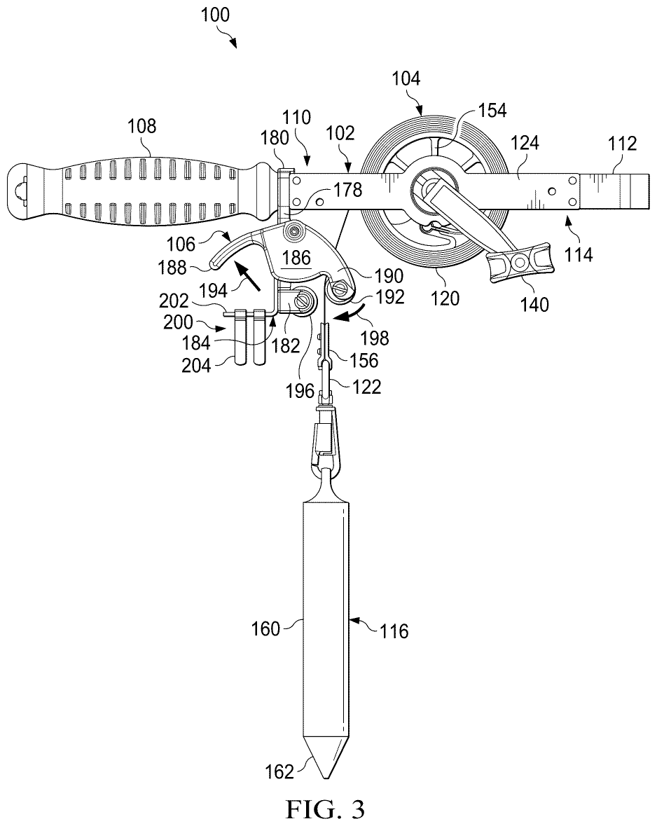

Referring now to FIGS. 1-3, a forward isometric view, top view and side view of the portable ullage measurement gauge 100 in accordance with one embodiment of the present disclosure are shown. The portable ullage measurement gauge 100 is useful for measuring the ullage of a filled or partially filled container, such as a cargo tank (i.e., the space between the cargo and the top of the tank), to determine the liquid level or volumetric equivalent of the liquid within the container. Thus, the portable ullage measurement gauge 100 includes a frame 102, a measurement tape assembly 104 rotatably connected to the frame 102, and a wiper assembly 106 connected to the frame 102. A handle 108 is connected to a rear end 110 of the frame 102 and a wiper ring 112 is connected to a forward end 114 of the frame 102. The handle 108 facilitates carrying and holding the portable ullage measurement gauge 100 by a user. The wiper ring 112 is sized to snugly receive a plumb bob 116 as it is being pulled through the wiper ring 112 to remove liquid and other debris from the surface of the plumb bob 116 after measuring the ullage of a storage tank. The wiper ring 112 can be made of plastic, rubber or other suitable material. A slot 118 is formed in a side of the wiper ring 112 for receiving a portion of the measurement tape 120 so that the measurement tape 120 can be pulled upwardly by the user to clean the plumb bob 116 without the necessity of its removal from the measurement tape 120. The slot 118 can be located anywhere along the exterior of the wiper ring 112. As shown, the slot 118 has a substantially vertical orientation. In other embodiments, the slot 118 can be at any angle from a bottom to a top of the wiper ring 112. In some embodiments, the wiper ring 112 does not have a slot 118 and the plumb bob 116 is cleaned by removing it from the measurement tape 120 using a clip or fastener 122.

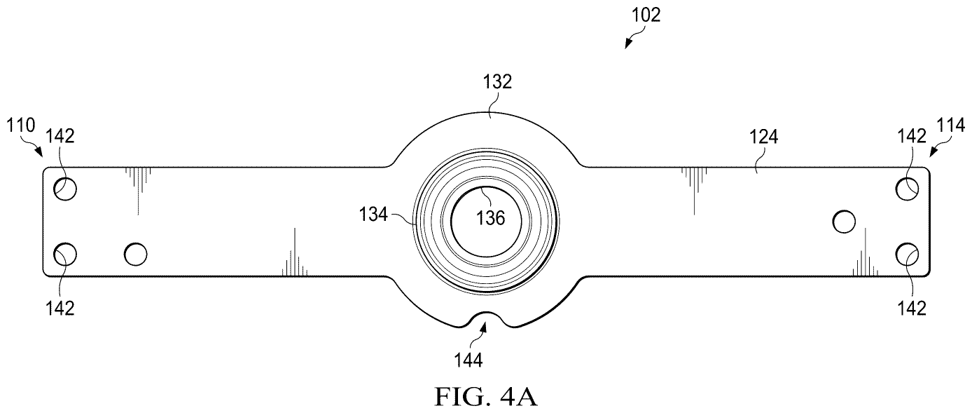

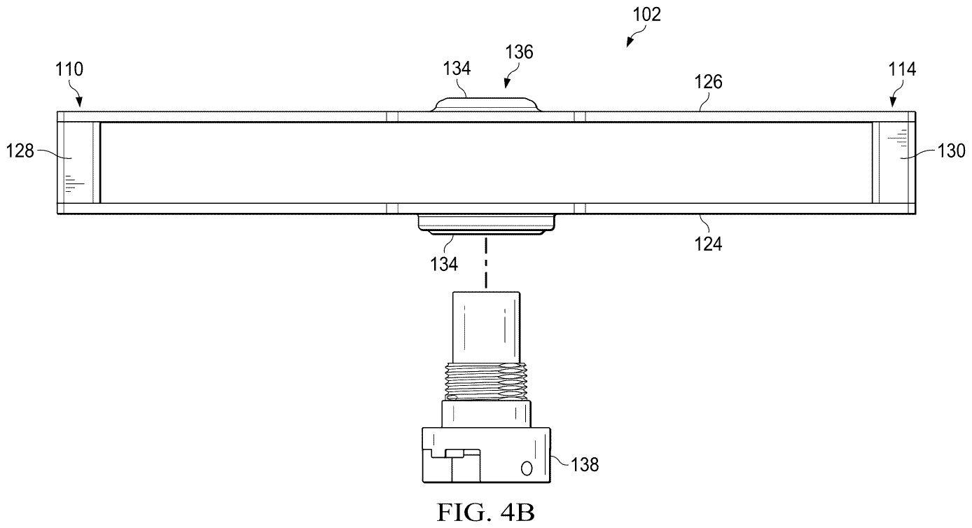

Now referring briefly to FIGS. 4A-4B, side and top views of the frame 102 in FIGS. 1-3 in accordance with one embodiment of the present disclosure are shown. The frame 102 includes a first plate member 124 connected to a second plate member 126 via a rear connector 128 and a forward connector 130. The first and second plate members 124 and 126 are preferably mirror identical, and each includes a circular central portion 132 with an attached bearing member 134 and an opening 136 for receiving the shaft 138 of a crank handle 140 (FIGS. 1-3) to thereby unwind and rewind the measurement tape 120 (FIGS. 1-3) during ullage measurement. In other embodiments, the circular central portions 132 are semi-circular central portions (not shown). In yet other embodiments, the first and second plate members 124, 126 do not include circular or semi-circular central portions 132. Openings 142 are formed in the rear end 110 and forward end 114 of each plate member 124, 126 to receive fasteners (not shown) that thread into the connectors 128, 130 to secure the plate members 124, 126 together in a spaced, parallel relationship. A notch or indent 144 is formed in a lower portion of the circular central portion 132 of each plate member 124, 126. Alternatively, the notch or indent 144 can be formed in an upper portion of the circular central portion 132, or in only one of the circular central portions 132. In other embodiments, the notch or indent 144 is formed in a lower or upper portion of the semi-circular central portion or the first and/or second plate members 124, 126.

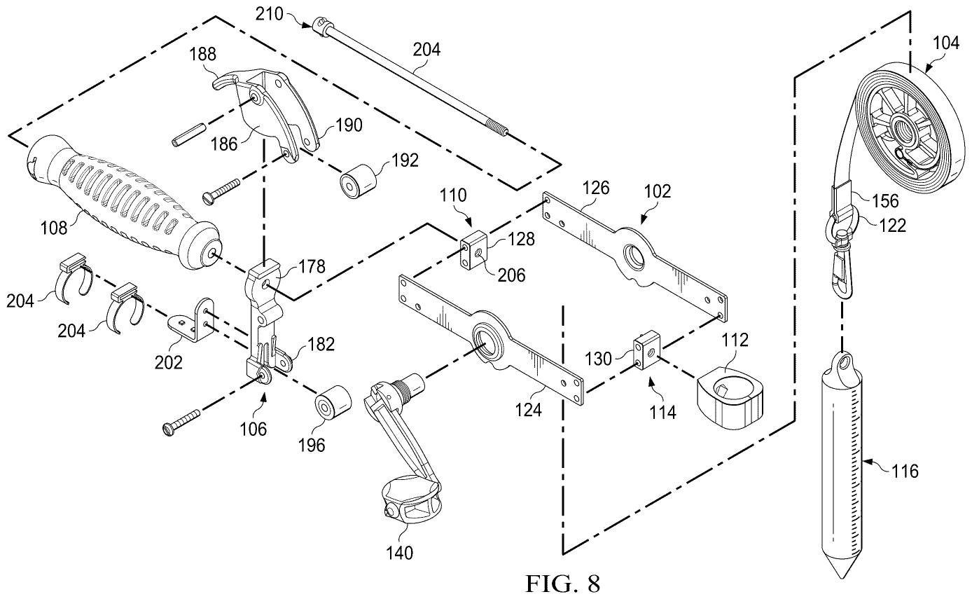

Referring now back to FIGS. 1-3, the measurement tape assembly 104 includes a reel 146 rotatably connected to the frame 102, the measurement tape 120 wound around the reel 146, and the crank handle 126 operably connected to rotate the reel 124. In some embodiments, the crank handle 126 can pivot about pin 148 for easier storage. The reel 146 has a central hub 150, an outer rim 152, and spokes 154 extending between the central hub 150 and the outer rim 152. A central opening 156 (FIG. 8) is formed in the central hub 150 that aligns with the opening 136 (FIGS. 4A-4B) of the bearing members 134 (FIGS. 4A-4B) for receiving the shaft 138 of the crank handle 140. The central hub 150 and shaft 138 are preferably fixed together so that rotation of the shaft 138 results in rotation of the central hub 150 and thus the winding/unwinding of the measurement tape 120. Accordingly, the measurement tape assembly 104 is rotatably connected to the frame member 102 between the first and second plate members 124 and 126, respectively. The plumb bob 116 is removeably attached to a free end 158 of the measurement tape 120 using the clip or fastener 122. The plumb bob 116 has a cylindrical section 160 and a conical end section 162. The plumb bob 116 is preferably constructed with a weight and/or density that is approximately equal to the weight of the fluid it displaces, so that the plumb bob 116 functions to both keep the measurement tape vertical during ullage measurement and to float on the fluid being measured so that a noticeable change in tension of the measurement tape 120 occurs when the plumb bob 116 is partially immersed in the fluid. Markings 164 on the plumb bob 116 can be used to measure the depth at which the plumb bob 116 is immersed in the oil or other liquid to help in calculating the actual ullage depth between the liquid and the top of the tank, as residual oil or other liquid on the plumb bob 116 remains when the measurement tape 120 is reeled in after the ullage measurement. The level of liquid remaining on the plumb bob 116 can also be used to determine a density of the liquid since the density/weight and shape of the plumb bob 116 are known, giving the user an indication of the volume of liquid displaced by the plumb bob 116.

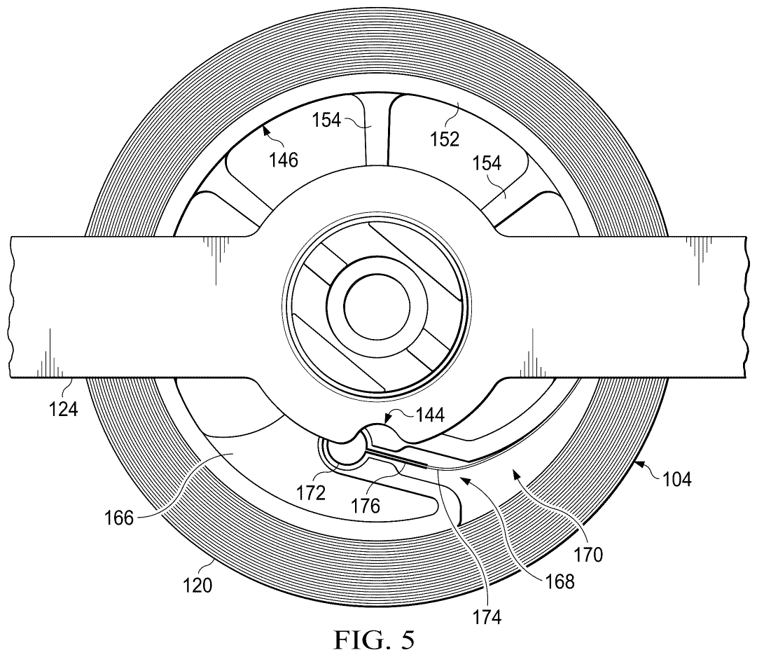

Now briefly referring to FIG. 5, a close-up view of the attachment of the measurement tape 120 to the reel 146 in FIGS. 1-3 in accordance with one embodiment of the present disclosure is shown. The reel 146 includes an enlarged spoke 166 between the central hub 150 and the outer rim 152. The enlarged spoke 166 has a cut-out portion 168 and the outer rim 152 has an opening 170 that together form an area used to receive and secure a pin 172 connected to a fixed end 174 of the measurement tape 120 via a connector 176. The notch or indent 144, the cut-out portion 168 and pin 172 are configured and sized to allow removal of the fixed end 174 of the measurement tape 120 when the notch or indent 144 is aligned with the pin 172. This allows easy replacement of the measurement tape 120 without disassembling the frame 102 or removing the reel 146.

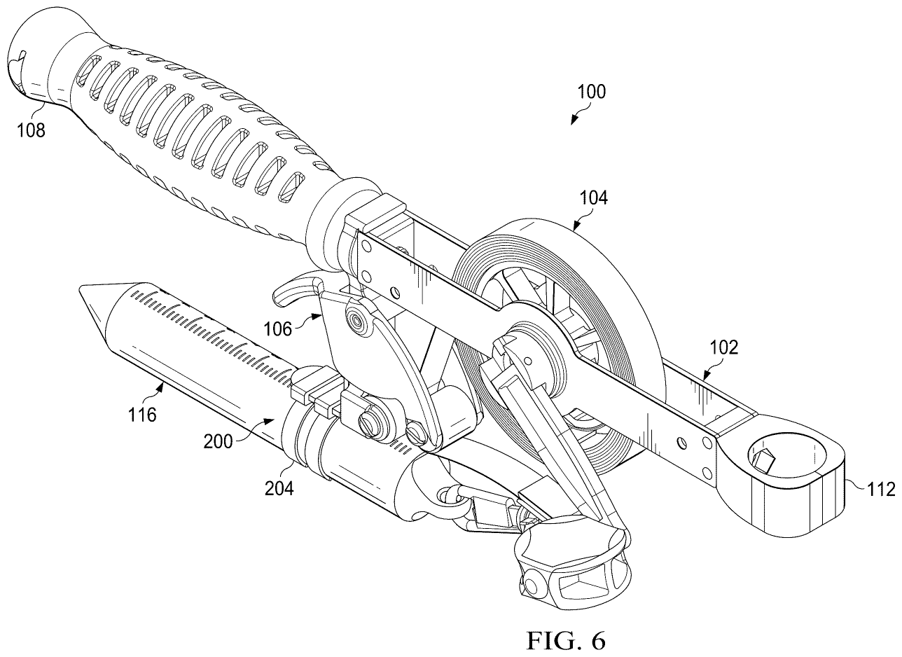

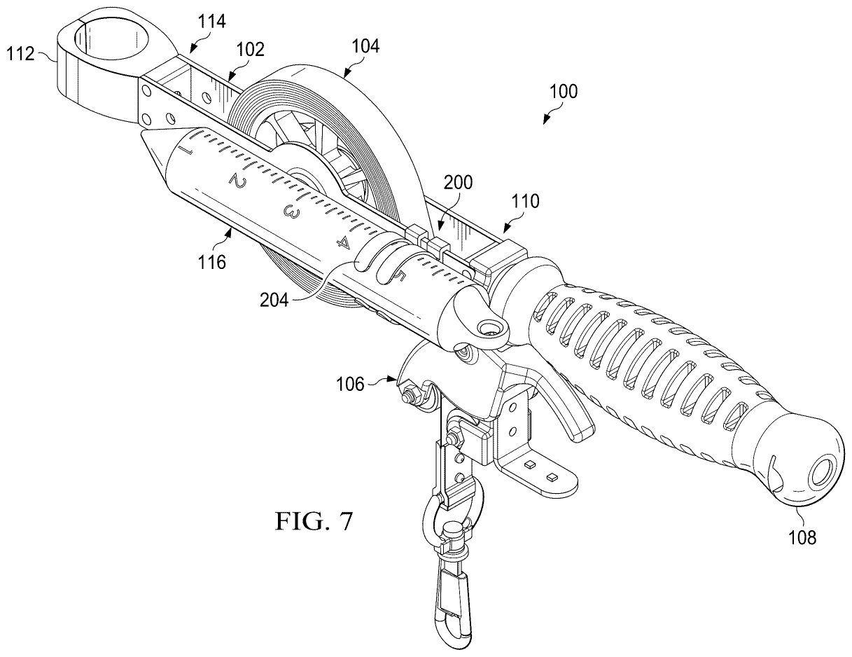

Referring now back to FIGS. 1-3, the wiper assembly 106 is connected to the frame 102 rearward of the measurement tape assembly 104 for cleaning the measurement tape 120 associated with the measurement tape assembly 104. The wiper assembly 106 includes an adapter 178 having an upper end 180 configured to be mounted between the rear end 110 of the frame 102 and the handle 108. The adapter 178 extends in a downward direction and has a pair of wiper tabs 182 at the lower end 184 of the adapter 178 that extend in a forward direction. An actuator or trigger arm 186 is pivotably attached to an upper portion of the adapter 178 below the frame 102 and handle 108. The actuator or trigger arm 186 includes a finger tab 188 that extends in a rearward direction under the handle 108 and a pair of wiper tabs 190 that extend forward and downward such that they are near the pair of wiper tabs 182 of the adapter 178. A first wiper element 192 is connected to the wiper tabs 190 of the actuator or trigger arm 186 so that applying an upward force on the finger tab 188, as represented by arrow 194, causes the first wiper element 192 to rotate towards a second wiper element 196, as represented by arrow 198, to thereby apply pressure against the measurement tape 120 located therebetween while the measurement tape 120 is being reeled in. The first and second wiper elements 192, 196 can adjustably contact both sides of the measurement tape 102. The second wiper element 196 is in turn mounted on wiper tabs 182 at the bottom of the adapter 178. In this manner, the second wiper element 196 is stationary with respect to the first wiper element 192 which rotates or pivots toward and away from the second wiper element 196 to thereby vary a squeegeeing pressure on the measurement tape 120. This construction is especially important when provided in combination with the handle 108 so that a user can easily hold and manipulate the portable ullage measurement gauge 100 with one hand during cleaning, while the other hand is used to reel the measurement tape 120 back in. The first and second wiper elements 192, 196 can be plastic, rubber or other suitable material. A plumb bob holder 200 is attached to the lower end of the adapter 178 (see also FIG. 6) or a side of the frame 102 (see FIG. 7).

Now referring to FIG. 6, a forward isometric view of the ullage measurement gauge 100 with the plumb bob 116 in a stored position in accordance with one embodiment of the present disclosure is shown. The plumb bob holder 200 is attached to the lower portion of the wiper assembly 106 with a L-shaped bracket 202 and stores the plumb bob 116 along the lower portion of the wiper assembly 106 when not in use. As shown, the plumb bob holder 200 can be two or more clips or semi-circular rings 204 sized to snugly receive a cylindrical section 160 of the plumb bob 116 in a snap-fit engagement. Alternatively, a single wider clip or semi-circular ring, hook and loop fastener, magnet or any other suitable fastener can be used to store the plumb bob 116 when not in use.

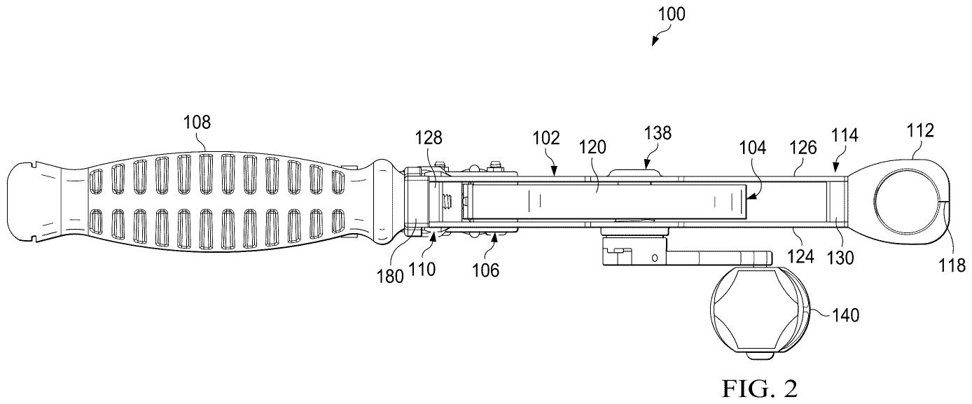

Referring now to FIG. 7, a rear isometric view of the ullage measurement gauge 100 with the plumb bob 116 in a stored position in accordance with another embodiment of the present disclosure is shown. The plumb bob holder 200 is attached to a side of the frame 102 and stores the plumb bob 116 along the side the frame 102 when not in use. As shown, the plumb bob holder 198 is attached at or near the rear end 110 of the frame 102 on side opposite the crank handle 140 (FIGS. 1-2). Alternatively, the plumb bob holder 200 can be attached closer to a middle portion of the frame 102 or the forward end 114 of the frame 102. Moreover, multiple plumb bob holders 142 can be attached along the frame 102. As shown, the plumb bob holder 200 can be two or more clips or semi-circular rings 204 sized to snugly receive a cylindrical section 160 of the plumb bob 116 in a snap-fit engagement. Alternatively, a single wider clip or semi-circular ring, hook and loop fastener, magnet or any other suitable fastener can be used to store the plumb bob 116 when not in use.

Now referring to FIG. 8, a forward isometric exploded view of the ullage measurement gauge in accordance with one embodiment of the present disclosure is shown. Most of the parts shown in FIG. 8 have been previously described in reference to FIGS. 1-7. The rear connector 128 includes a threaded opening 206 for receiving a threaded grounding rod 208 extending through the handle 108 to thereby secure the handle 108 to the rear connector 128 and thus the frame 102. As a result, the threaded grounding rod 208 is electrically connected to the frame 102. In some embodiments the grounding rod 208 is not threaded and is electrically connected to the frame using other removeable connectors or permanent connections. A rear end 210 of the grounding rod 208 is configured to be electrically connected to an external ground (not shown). As shown, the rear end 210 of the grounding rod 208 is accessible via rear end 210 or sides 214 of the handle 108. In some embodiments, the handle 108 may include a grounding connector or wire (not shown) electrically connected to the grounding rod 208. The handle 108 should be made of a non-electrically conductive material, such as plastic, rubber, wood, etc.

In one embodiment of the present disclosure, a portable ullage gauge includes a frame, a measurement tape assembly and a wiper assembly. The measurement tape assembly includes a reel rotatably connected to the frame and a measurement tape wound around the reel, wherein the reel includes an opening configured to secure a fixed end of the measurement tape. The wiper assembly is connected to the frame and includes a first wiper element and a second wiper element that are spaced apart such that the measurement tape passes between the first wiper element and the second wiper element. The second wiper element is stationary and the first wiper element is rotatable towards the second wiper element to adjustably contact both sides of the measurement tape. The frame includes a notch that is alignable with the opening in the reel such that the measurement tape is removeable.

In one aspect, the notch is located on an upper or lower portion of the frame member. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, the reel is rotatably connected between the first circular or semi-circular central portion of the first plate member and the second circular or semi-circular central portion of the second plate member, and the notch is on the first circular or semi-circular central portion, the second circular or semi-circular central portion, or both. In another aspect, the wiper assembly further includes an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a wiper ring is connected to a front end of the frame. In another aspect, a slot is formed in the wiper ring. In another aspect, a plumb bob holder is connected to the wiper assembly or the frame. In another aspect, the plumb bob holder includes one or more clips, semi-circular rings, hook and loop fasteners, or magnets.

In another embodiment of the present disclosure, a portable ullage gauge includes a frame, a measurement tape assembly, a wiper assembly connected to the frame, and a wiper ring connected to a front end of the frame. The measurement tape assembly includes a reel rotatably connected to the frame and a measurement tape wound around the reel. The wiper assembly includes a first wiper element and a second wiper element that are spaced apart such that the measurement tape passes between the first wiper element and the second wiper element. The second wiper element is stationary and the first wiper element is rotatable towards the second wiper element to adjustably contact both sides of the measurement tape.

In one aspect, a slot is formed in the wiper ring. In another aspect, an opening in the reel is configured to secure a fixed end of the measurement tape, and a notch in the frame that is alignable with the opening in the reel such that the measurement tape is removeable. In another aspect, the notch is located on an upper or lower portion of the frame. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, and the reel is rotatably connected between the first circular or semi-circular central portion of the first plate member and the second circular or semi-circular central portion of the second plate member. In another aspect, the notch is on the first circular or semi-circular central portion, the second circular or semi-circular central portion, or both. In another aspect, the wiper assembly further comprises an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a plumb bob holder is connected to the wiper assembly or the frame. In another aspect, the plumb bob holder includes one or more clips, semi-circular rings, hook and loop fasteners, or magnets.

In another embodiment of the present disclosure, a portable ullage gauge includes a frame, a measurement tape assembly, a wiper assembly connected to the frame, and a plumb bob holder connected to the wiper assembly or the frame. The measurement tape assembly includes a reel rotatably connected to the frame and a measurement tape wound around the reel. The wiper assembly includes a first wiper element and a second wiper element that are spaced apart such that the measurement tape passes between the first wiper element and the second wiper element. The second wiper element is stationary and the first wiper element is rotatable towards the second wiper element to adjustably contact both sides of the measurement tape.

In oner aspect, the plumb bob holder includes one or more clips, semi-circular rings, hook and loop fasteners, or magnets. In another aspect, an opening in the reel is configured to secure a fixed end of the measurement tape, and a notch in the frame is alignable with the opening in the reel such that the measurement tape is removeable. In another aspect, the notch is located on an upper or lower portion of the frame member. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, and the reel is rotatably connected between the first circular or semi-circular central portion of the first plate member and the second circular or semi-circular central portion of the second plate member. In another aspect, the notch is on the first circular or semi-circular central portion, the second circular or semi-circular central portion, or both. In another aspect, the wiper assembly includes an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a wiper ring is connected to a front end of the frame. In another aspect, a slot is formed in the wiper ring.

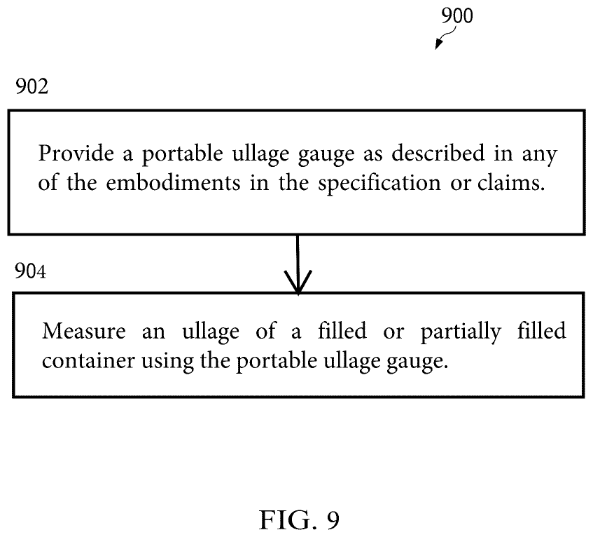

Referring now to FIG. 9, a flow chart of a method 900 of using a ullage measurement gauge in accordance with one embodiment of the present disclosure is shown. The method of using a portable ullage gauge includes providing a portable ullage gauge as described in any of the foregoing embodiments in block 902 and measuring an ullage of a filled or partially filled container, such as a tank, using the portable ullage gauge in block 904.

In one aspect, the method includes removing or replacing the measurement tape by aligning the notch in the frame with the opening in the reel. In another aspect, the method includes wiping a liquid or material off the measurement tape using the first and second wiper elements. In another aspect, the method includes wiping a liquid or material off the plumb bob using the wiper ring. In another aspect, the method includes storing the plumb bob using the plumb bob holder. In another aspect, an opening in the reel is configured to secure a fixed end of the measurement tape, and a notch in the frame is alignable with the opening in the reel such that the measurement tape is removeable. In another aspect, the notch is located on an upper or lower portion of the frame member. In another aspect, the opening in the reel is configured to removeably and securely receive a pin connected to the fixed end of the measurement tape. In another aspect, the measurement tape is removeable without disassembling the frame or removing the reel. In another aspect, the frame includes a first plate member connected in parallel to a second plate member using a rear connector and a front connector, and the reel is rotatably connected between the first plate member and the second plate member. In another aspect, the first plate member has a first circular or semi-circular central portion, the second plate member has a second circular or semi-circular central portion, the reel is rotatably connected between the first circular or semi-circular central portion of the first plate member and the second circular or semi-circular central portion of the second plate member, and the notch is on the first circular or semi-circular central portion, the second circular or semi-circular central portion, or both. In another aspect, the wiper assembly further includes an actuator to move the first wiper element towards the second wiper element. In another aspect, a handle is connected to a rear end of the frame, and a crank handle is connected to the reel. In another aspect, a grounding rod is disposed within the handle and electrically connected to the frame. In another aspect, a plumb bob is removeably connected to the measurement tape. In another aspect, a wiper ring is connected to a front end of the frame. In another aspect, a slot is formed in the wiper ring. In another aspect, a plumb bob holder is connected to the wiper assembly or the frame. In another aspect, the plumb bob holder includes one or more clips, semi-circular rings, hook and loop fasteners, or magnets.

It is understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

What is claimed is:

1. A portable ullage gauge comprising:
a frame;
a measurement tape assembly comprising a reel rotatably connected to the frame and a measurement tape wound around the reel, wherein the reel includes an opening configured to secure a fixed end of the measurement tape;
a wiper assembly connected to the frame, the wiper assembly comprising a first wiper element and a second wiper element that are spaced apart such that the measurement tape passes between the first wiper element and the second wiper element, wherein the second wiper element is stationary and the first wiper element is rotatable towards the second wiper element to adjustably contact both sides of the measurement tape; and
wherein the frame includes a notch that is alignable with the opening in the reel such that the measurement tape is removeable.

2. The portable ullage gauge of claim 1, wherein the notch is located on an upper or lower portion of the frame.

3. The portable ullage gauge of claim 1, wherein the opening in the reel is configured to removeably and securely receive a pin connected to the fixed end of the measurement tape.

4. The portable ullage gauge of claim 1, wherein the measurement tape is removeable without disassembling the frame or removing the reel.

5. The portable ullage gauge of claim 1, wherein the frame comprises:
a first plate member connected in parallel to a second plate member using a rear connector and a front connector; and
wherein the reel is rotatably connected between the first plate member and the second plate member.

6. The portable ullage gauge of claim 5, wherein:
the first plate member has a first circular or semi-circular central portion;
the second plate member has a second circular or semi-circular central portion;
the reel is rotatably connected between the first circular or semi-circular central portion of the first plate member and the second circular or semi-circular central portion of the second plate member; and
the notch is on the first circular or semi-circular central portion, the second circular or semi-circular central portion, or both.

7. The portable ullage gauge of claim 1, wherein the wiper assembly further comprises an actuator to move the first wiper element towards the second wiper element.

8. The portable ullage gauge of claim 1, further comprising:
a handle connected to a rear end of the frame; and
a crank handle connected to the reel.

9. The portable ullage gauge of claim 7, further comprising a grounding rod disposed within the handle and electrically connected to the frame.

10. The portable ullage gauge of claim 1, further comprising a plumb bob removeably connected to the measurement tape.

11. The portable ullage gauge of claim 1, further comprising a wiper ring connected to a front end of the frame.

12. The portable ullage gauge of claim 11, further comprising a slot formed in the wiper ring.

13. The portable ullage gauge of claim 1, further comprising a plumb bob holder connected to the wiper assembly or the frame.

14. The portable ullage gauge of claim 13, wherein the plumb bob holder comprises one or more clips, semi-circular rings, hook and loop fasteners, or magnets.

15. A portable ullage gauge comprising:
a frame;
a measurement tape assembly comprising a reel rotatably connected to the frame and a measurement tape wound around the reel;
a wiper assembly connected to the frame, the wiper assembly comprising a first wiper element and a second wiper element that are spaced apart such that the measurement tape passes between the first wiper element and the second wiper element, wherein the second wiper element is stationary and the first wiper element is rotatable towards the second wiper element to adjustably contact both sides of the measurement tape; and
a wiper ring connected to a front end of the frame.

16. The portable ullage gauge of claim 15, further comprising a slot formed in the wiper ring.

17. The portable ullage gauge of claim 15, further comprising:
an opening in the reel configured to secure a fixed end of the measurement tape; and
a notch in the frame that is alignable with the opening in the reel such that the measurement tape is removeable.

18. The portable ullage gauge of claim 17, wherein the notch is located on an upper or lower portion of the frame.

19. The portable ullage gauge of claim 17, wherein the opening in the reel is configured to removeably and securely receive a pin connected to the fixed end of the measurement tape.

20. The portable ullage gauge of claim 17, wherein the measurement tape is removeable without disassembling the frame or removing the reel.

21. The portable ullage gauge of claim 15, wherein the frame comprises:
a first plate member connected in parallel to a second plate member using a rear connector and a front connector; and
wherein the reel is rotatably connected between the first plate member and the second plate member.

22. The portable ullage gauge of claim 21, wherein:
the first plate member has a first circular or semi-circular central portion;
the second plate member has a second circular or semi-circular central portion; and
the reel is rotatably connected between the first circular or semi-circular central portion of the first plate member and the second circular or semi-circular central portion of the second plate member.

23. The portable ullage gauge of claim 22, wherein the notch is on the first circular or semi-circular central portion, the second circular or semi-circular central portion, or both.

24. The portable ullage gauge of claim 15, wherein the wiper assembly further comprises an actuator to move the first wiper element towards the second wiper element.

25. The portable ullage gauge of claim 15, further comprising:
a handle connected to a rear end of the frame; and
a crank handle connected to the reel.

26. The portable ullage gauge of claim 25, further comprising a grounding rod disposed within the handle and electrically connected to the frame.

27. The portable ullage gauge of claim 15, further comprising a plumb bob removeably connected to the measurement tape.

28. The portable ullage gauge of claim 15, further comprising a plumb bob holder connected to the wiper assembly or the frame.

29. The portable ullage gauge of claim 28, wherein the plumb bob holder comprises one or more clips, semi-circular rings, hook and loop fasteners, or magnets.

30. A portable ullage gauge comprising:
a frame;
a measurement tape assembly comprising a reel rotatably connected to the frame and a measurement tape wound around the reel;
a wiper assembly connected to the frame, the wiper assembly comprising a first wiper element and a second wiper element that are spaced apart such that the measurement tape passes between the first wiper element and the second wiper element, wherein the second wiper element is stationary and the first wiper element is rotatable towards the second wiper element to adjustably contact both sides of the measurement tape; and
a plumb bob holder connected to the wiper assembly or the frame.

31. The portable ullage gauge of claim 30, wherein the plumb bob holder comprises one or more clips, semi-circular rings, hook and loop fasteners, or magnets.

32. The portable ullage gauge of claim 30, further comprising:
an opening in the reel configured to secure a fixed end of the measurement tape; and
a notch in the frame that is alignable with the opening in the reel such that the measurement tape is removeable.

33. The portable ullage gauge of claim 32, wherein the notch is located on an upper or lower portion of the frame.

34. The portable ullage gauge of claim 32, wherein the opening in the reel is configured to removeably and securely receive a pin connected to the fixed end of the measurement tape.

35. The portable ullage gauge of claim 32, wherein the measurement tape is removeable without disassembling the frame or removing the reel.

36. The portable ullage gauge of claim 30, wherein the frame comprises:
a first plate member connected in parallel to a second plate member using a rear connector and a front connector; and
wherein the reel is rotatably connected between the first plate member and the second plate member.

37. The portable ullage gauge of claim 36, wherein:
the first plate member has a first circular or semi-circular central portion;
the second plate member has a second circular or semi-circular central portion; and
the reel is rotatably connected between the first circular or semi-circular central portion of the first plate member and the second circular or semi-circular central portion of the second plate member.

38. The portable ullage gauge of claim 37, wherein the notch is on the first circular or semi-circular central portion, the second circular or semi-circular central portion, or both.

39. The portable ullage gauge of claim 30, wherein the wiper assembly further comprises an actuator to move the first wiper element towards the second wiper element.

40. The portable ullage gauge of claim 30, further comprising:
a handle connected to a rear end of the frame; and
a crank handle connected to the reel.

41. The portable ullage gauge of claim 40, further comprising a grounding rod disposed within the handle and electrically connected to the frame.

42. The portable ullage gauge of claim 30, further comprising a plumb bob removeably connected to the measurement tape.

43. The portable ullage gauge of claim 30, further comprising a wiper ring connected to a front end of the frame.

44. The portable ullage gauge of claim 43, further comprising a slot formed in the wiper ring.
